(19) United States
(12) Patent Application Publication
(10) Pub. No.: US 2005/0251605 A1
(43) Pub. Date: Nov. 10, 2005

(54) Apparatus and method for communications between agents in PCI system

(75) Inventors: Seung-Soo Oak, Seongnam-si (KR); Sang-Hyong Lee, Seoul (KR); Jin-Hyung Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/001,322

(22) Filed: Dec. 2, 2004

(30) Foreign Application Priority Data
May 8, 2004 (KR) 2004-32458

(51) Int. Cl. G06F 13/14

(52) U.S. Cl. 710/260

(57) ABSTRACT

The present invention discloses a method for sending data from a second agent to a first agent in a bus system having a host and at least two agents of the first agent and at least one second agent. The first and second agents are connected by an interrupt signal line externally provided to the bus system, and the second agent sends an interrupt signal to the second agent without the intervention of the host. The first agent having received the interrupt signal directly receives data stored in the second agent.

### CROSS-REFERENCE TO RELATED APPLICATION

This application claims the benefit under 35 U.S.C. §119(a) of Korean Patent Application No. 2004-32458, filed on May 8, 2004, the entire contents of which is incorporated herein by reference.

### BACKGROUND OF THE INVENTION

1. Field of the Invention

The present invention relates to a PCI local bus system, and more particularly to an apparatus and method for communicating between agents constituting the PCI local bus system.

2. Description of the Related Art

The Peripheral Component Interconnect (PCI) local bus is a kind of local bus providing data pathways that directly connect the central processing unit (CPU) and peripheral devices and transfer data at a high speed, and has an advantage of much better stability or expandability than the existing (Video Electronics Standard Association (VESA) local) (VL) bus. Unlike the VL bus, the PCI bus can be connected to any kind of system CPU. That is, since the PCI bridge interfaces the system CPU with the PCI bus, the PCI bus can be connected to any system CPU if a PCI bridge is provided for a system CPU. Hereinafter, description will be made of data transfers and connections between devices on the PCI local bus that constitute a system with reference to FIG. 1.

FIG. 1 shows a host 100, an agent 102, and a PCI local bus on which the host 100 and the agent 102 are connected. The host 100 is a device for controlling the PCI local bus, and the agent 102 is a device providing additional functions to the host 100 through the PCI local bus. For example, if the PC serves as a host, a network card, sound card, graphic card, and the like serve as agents. Further, if an image-forming apparatus serves as a host, a network printer card, wireless LAN module, hard disk drive (HDD), and the like serve as agents.

The PCI local bus of FIG. 1 consists of two signal lines, connecting the host 100 and the agent 102. The two signal lines consist of an interrupt signal line and a signal line transferring signals other than interrupt signals. The interrupt refers to stopping a current job and carrying out a job according to an unexpected state, if an unexpected event occurs. The interrupt signal is a signal requesting the execution of a job according to an unexpected state if the unexpected state occurs.

The interrupt signal is generated due to power failure, requests by peripheral devices, data input and output terminations, error occurrences, and so on.

The agent 102 generates an interrupt signal to the PCI local bus in order to control the host 100 when state changes or data transfer requests are needed. The host 100 becomes aware of the generation of an interrupt signal by checking the PCI local bus. If the interrupt signal appears on the PCI local bus, the host 100 checks the state of the agent 102 connected on the PCI local bus, and runs the necessary interrupt service routines.

In FIG. 1, the agent 102 sends an interrupt signal to the host 100 by using the interrupt signal line, and sends signals other than interrupt signals by using the signal line.

FIG. 2 shows a host 200, two agents 202 and 204, and a PCI local bus connecting the host 200 and the two agents 202 and 204. The two agents are agent 1 (202) and agent 2 (204). The PCI local bus can have at least one agent, but FIG. 2 shows two agents for the convenience of explanation.

FIG. 2 shows two signal lines as in FIG. 1. That is, the two signal lines are an interrupt signal line for sending an interrupt signal and a signal line for sending signals other than interrupts. The agent 204 sends an interrupt signal to the host 200 as well as to agent 202 via the host 200. The same description as in FIG. 1 will be applied if the agent 204 sends an interrupt signal to the host 200.

However, if the agent 204 sends an interrupt signal to the agent 202, the agent 204 can not directly send the interrupt signal to the agent 202. As described above, the host 200 controls all devices connected to the PCI local bus. Thus, the interrupt signal to be sent from the agent 202 to the agent 204 is sent via the host 200.

For example, if the agent 204 sends to the agent 202 data and an interrupt signal for sending the data, the agent 204 does not have a device driver that can access the memory of the agent 202. Thus, the agent 204 can not send to the agent 202 an interrupt signal as well as data. The host 200 manages the device drivers for the devices connected to the PCI local bus. Therefore, if the agent 204 sends an interrupt signal to the host 200, the host 200 reads out data stored in the agent 204. Thus, it is possible that the agent 204 first sends data to and stores data in the host 200, and then sends an interrupt signal to the host 200. The host 200 sends the stored data to the agent 202 by use of the received interrupt signal. The host 200 sends data to the agent 202 in the same manner as the agent 204 sends data to the host 200.

As described above, since the agent 204 does not have a device driver for directly controlling the agent 202, the host 200 has to interface between the two. That is, the agent 202 first sends data and an interrupt signal to the host 200, and then the host 200 sends its received data and interrupt signal to the agent 202, which increases the traffic on the entire PCI local bus as well as affects the performance of the host.

### SUMMARY OF THE INVENTION

The present invention has been developed in order to solve the above drawbacks and other problems associated with the conventional arrangement. An aspect of the present invention is to provide a method for increasing the processing speed of data transferring between agents.

An aspect of the present invention is a method in which a host does not control all agents, but a specific agent controls another agent.

Another aspect of the present invention is to provide a method for increasing a system efficiency by reducing the load of a PCI local bus system.

Yet another aspect of the present invention is to provide a method for reducing the cost for new functions by using existing components.

The foregoing and other objects and advantages are substantially realized by providing a bus system comprising a host for controlling the bus system; a first agent for sending and receiving data to and from the host; and at least one second agent for directly sending and receiving data to and from the first agent.

Preferably, the host initializes a device driver of the first agent to control the first agent.

Preferably, the first and second agents are directly connected through an interrupt signal line for sending and receiving an interrupt signal. The interrupt signal can indicate whether data is ready to be sent occurs.

Preferably, the first and second agents are connected through an interrupt signal line externally provided to the bus system.

The foregoing and other objects and advantages are substantially realized by providing a method for controlling a bus system having a host and at least two agents comprising at least a first agent and at least one second agent. The method comprises the steps of activating the bus system; setting a device driver of the first agent for driving the first agent by the host; and setting a device driver of the second agent for driving the second agent by the first agent.

### BRIEF DESCRIPTION OF THE DRAWINGS

The above aspects and features of the present invention will be more apparent by describing certain embodiments of the present invention with reference to the accompanying drawings, in which:

FIG. 1 is a view showing a conventional PCI local bus connecting a host and an agent;

FIG. 2 is a view showing a conventional PCI local bus connecting a host and two agents;

FIG. 3 is a view showing the exemplary operations of an agent according to an embodiment of the present invention;

FIG. 4 is a view showing the exemplary operations of a first agent according to an embodiment of the present invention;

FIG. 5 is a view showing the exemplary operations of a second agent according to an embodiment of the present invention;

FIG. 6 is a view showing a PCI local bus sending data from a first agent to a second agent according to an embodiment of the present invention; and

FIG. 7 is a view showing a PCI local bus sending data from the first agent to the second agent according to another embodiment of the present invention.

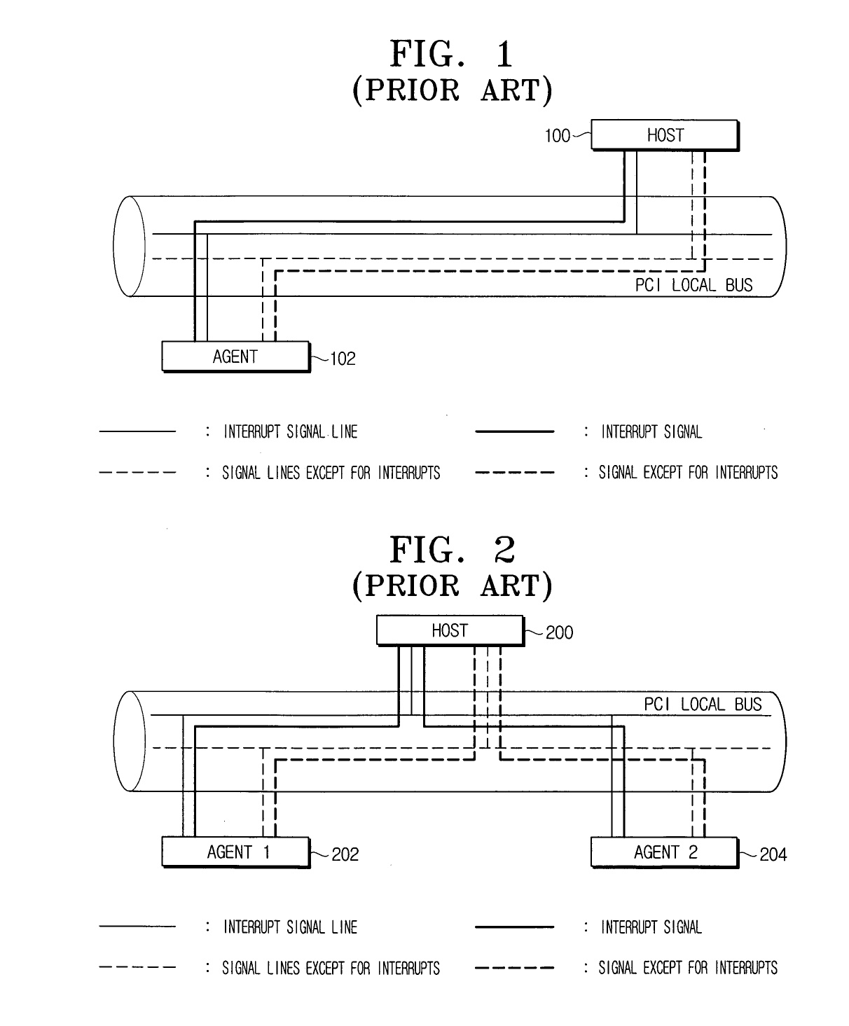

### DETAILED DESCRIPTION OF THE EXEMPLARY EMBODIMENTS

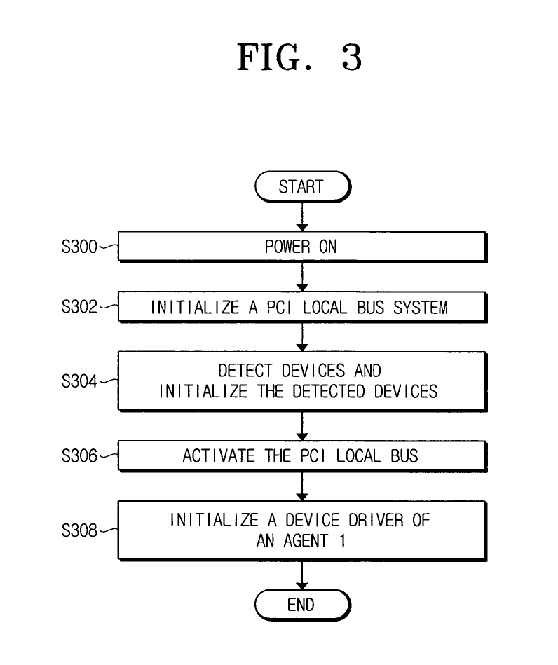

Hereinafter, description will be made in detail of exemplary embodiments of the present invention with reference to accompanying drawings. Description will be made of the operations of each agent in a PCI local bus system having one host and two agents with reference to FIG. 3 through FIG. 5. Further, description will be made on the host constituting the PCI local bus system with reference to FIG. 3.

FIG. 3 is a view showing the exemplary operations of a host constituting a PCI local bus system according to an embodiment of the present invention.

The PCI local bus system is turned on (S300). The host initializes the PCI local bus system (S302). With the initialization of the PCI local bus system, the host initializes information necessary for itself. That is, the host initializes the PCI memory size, cacheline size, and the like. Further, the host initializes variables for activating the PCI local bus system.

The host detects all devices constituting the PCI local bus system, and initializes the detected devices (S304). The initialization of the devices includes a process of assigning memory regions requested by the devices to the PCI addresses. That is, if the agent 1 requests a memory region x and the agent 2 requests a memory region y, the host assigns the PCI addresses to avoid the overlapping of the requested memory regions x and y. With the PCI addresses assigned, the devices obtain address information related to the memory to be used by themselves. That is, the devices can use the memory within the assigned PCI addresses.

If the devices of the PCI local bus system are successfully initialized, the PCI local bus is activated (S306). The host initializes the device drivers for some devices, such as an agent, constituting the PCI local bus system (S308). The host can be set in advance to have the device drivers to be initialized for the devices. According to an embodiment of the present invention, the host does not initialize the device drivers for all the devices, but initializes the device drivers for a part of the devices. The host stores identifiers of the devices for which the device addresses are initialized, and checks whether any of the identities already exist.. If as a result of the check, the host determines that devices having the same identifiers as the stored identifiers exist, the host initializes the device drivers for the existing devices. Through the initialization of the device drivers, the host controls general operations of the devices whose device drivers have been initialized. That is, the host controls the corresponding devices by determining the use of the assigned PCI addresses. As described above, according to embodiments of the present invention, the host initializes the device drivers for only some of the devices, by which the load to the PCI local bus system can be reduced.

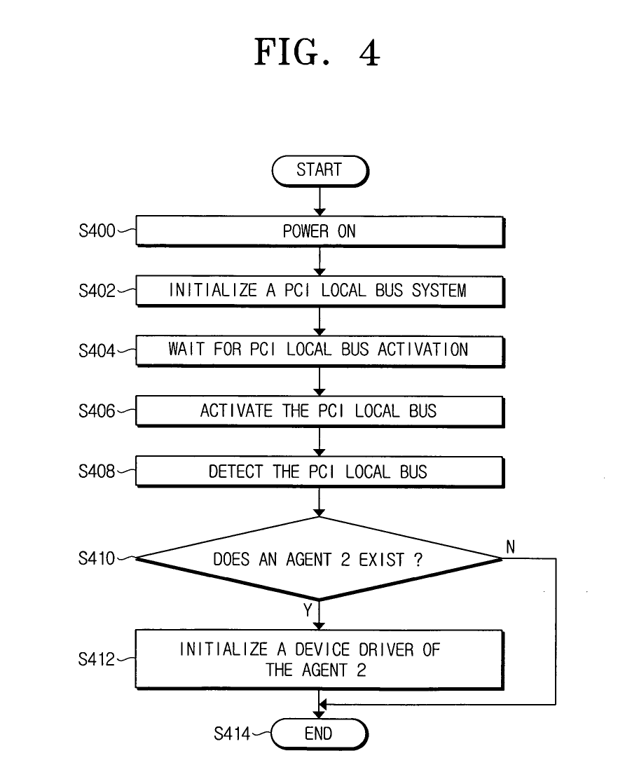

FIG. 4 is a view showing the exemplary operations of a first agent according to an embodiment of the present invention. The agent 1 is a device whose device driver is initialized by the host, as described in FIG. 3. Hereinafter, description will be made in detail of operations of the agent 1 whose device driver is initialized by the host with reference to FIG. 4 according to an embodiment of the present invention.

The PCI local bus system is turned on (S400). The agent 1 initializes the PCI local bus system (S402). The agent 1 requests the host to assign addresses to a memory region for itself as well as to a memory region related to an agent 2. That is, the existing agent 1 receives data via the host since it does not have a memory for directly receiving data sent by the agent 2, but, in embodiments of the present invention, the agent 1 can directly receive data sent by the agent 2 since the agent 1 requests the host for a memory region related to the agent 2.

The agent 1 waits for the PCI local bus to be activated (S404). The PCI local bus is activated (S406). With the PCI local bus activated, the agent 1 is assigned PCI addresses for the memory region requested. That is, the agent 1 is assigned the PCI addresses for the memory region related to the agent 2 as well as memory regions for itself.

The agent 1 detects the PCI local bus (S408). The agent 1 decides whether the agent 2 is detected (S410). The agent 2 is a device whose device driver is initialized by the agent 1. FIG. 4 shows that the agent 1 detects only one device as an example, but, in other embodiments of the present invention, the agent 1 is not limited to detecting only one device. That is, the agent 1 detects all devices whose device drivers are initialized by the agent 1 (S410). However, FIG. 4 shows that the agent 1 is limited to detecting one device for the sake of convenience. The agent 1 stores the identifiers of the devices whose device drivers are initialized, and decides whether the same identifiers as those stored are detected. If the same identifiers as those stored exist as a result of the decision, the agent 1 initializes the device drivers for the existing devices. In FIG. 4, the agent 1 has the agent 2 as a device whose device driver is initialized, and stores the identifier of the agent 2. Thus, the agent 1 decides whether the agent 2 exists on the PCI local bus (S410). If the agent 2 exists as a result of the decision, step S412 is carried out, and, if the agent 2 does not exist, step S414 is carried out, and the whole process is terminated.

In step S412, the agent 1 initializes the device driver of the agent 2. With step S412 carried out, the agent 1 can control agent 2. That is, the agent 1 controls the agent 2 by deciding the use of the PCI addresses assigned relating to the agent 2.

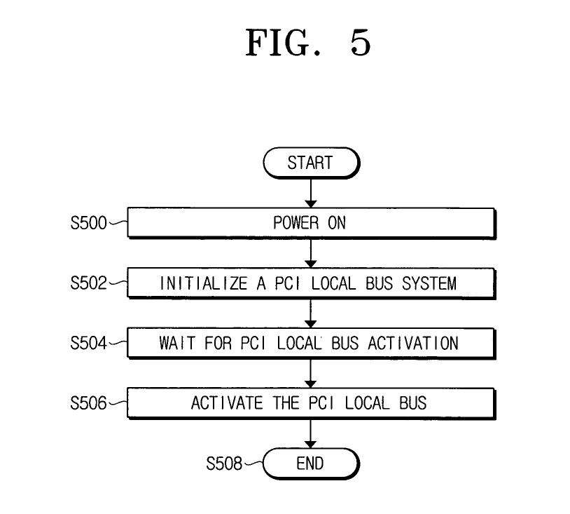

FIG. 5 is a view showing the operations of the agent 2 according to an exemplary embodiment of the present invention. Hereinafter, description will be made in detail on the operations of the agent 2 with reference to FIG. 5 according to an embodiment of the present invention.

The PCI local bus system is turned on (S500). The agent 2 initializes the PCI local bus system (S502). The agent 2 requests to the host for address assignment to the memory region to be used by itself (S502). The agent 2 waits for the PCI local bus to be activated (S504). The PCI local bus is activated (S506). With the PCI local bus activated, the agent 2 is assigned the PCI addresses of the requested memory region.

Embodiments of the present invention divide the functions carried out in the devices constituting the PCI local bus, as stated above into three functions. The three functions are a host controlling general operations of the devices constituting the PCI local bus, an agent 1 of which operations are controlled by the host, and an agent 2 of which operations are controlled by the agent 1. As stated above, a part of the functions of the host is executed in the agent 1, so the load to the PCI local bus is reduced.

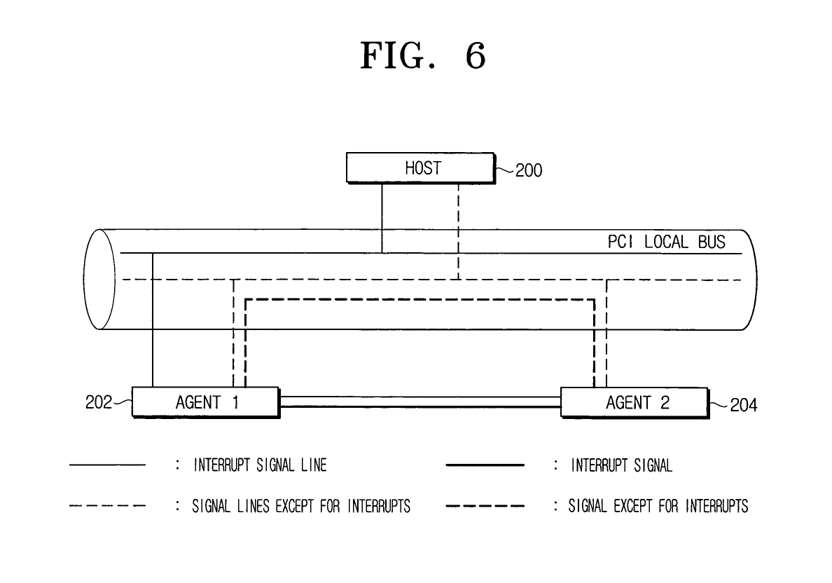

FIG. 6 is a view showing a process for sending data between agents according to an exemplary embodiment of the present invention. Hereinafter, description will be made in detail on a process for sending data from the agent 2 to the agent 1 with reference to FIG. 6.

FIG. 6 shows a PCI local bus system constituting the host 200, agent 202 (agent 1), and agent 204 (agent 2). In general, the PCI local bus system may include other devices in addition to the above devices, but FIG. 6 shows that the devices are limited to the host 200, agent 202, and agent 204 for the sake of convenience.

As described in FIG. 3 to FIG. 6, the agent 204 is controlled by the agent 202. Hereinafter, description will be made on the relationship between the agents 202 and 204, for example. It is assumed that a wire network printer card is connected to the PCI local bus in the image-forming apparatus. The wire network printer card processes packets and sends necessary information to the image-forming apparatus. If a wireless function is to be added to the image-forming apparatus, it is not efficient to add a wireless network printer card for use instead of the wire network printer card. In other words, the wire and wireless network printer cards are needed to implement an image-forming apparatus having both wire and wireless functions. However, the image-forming apparatus including the wire and wireless network printer cards increases the cost as well as the volume of the image forming apparatus. For such circumstances, it is desirable to add only a wireless module capable of processing wireless packets. That is, it is preferable that the wireless module processes wireless packets and the wire network printer card processes the processed wireless packets. For instance, the wire network printer card carries out the function of the agent 1, and the wireless module carries out the function of the agent 2.

As described above, the time for processing packets is delayed if the wireless module passes through the printer (host), and traffic on the PCI local bus also increases.

As shown in FIG. 6, the agent 202 is directly connected to the agent 204 by an interrupt signal line. If the agent 204 has data to be sent to the agent 202, the agent 202 sends a signal indicating whether it has data by using the interrupt signal line. The agent 202 becomes aware that the data to be sent to the agent 202 has been stored in the agent 204, using information sent through the interrupt signal line. Since the agent 202 has a memory region for the agent 204, the agent 202 can receive the data regardless of the host 200. The agent 204 first generates an interrupt, so the agent 204 can notify the agent 202 that the agent 204 has data to be sent to the agent 202. Further, the agent 204 first sends the data to the agent 202, and generates an interrupt, enabling the agent 202 to process the data that has been sent.

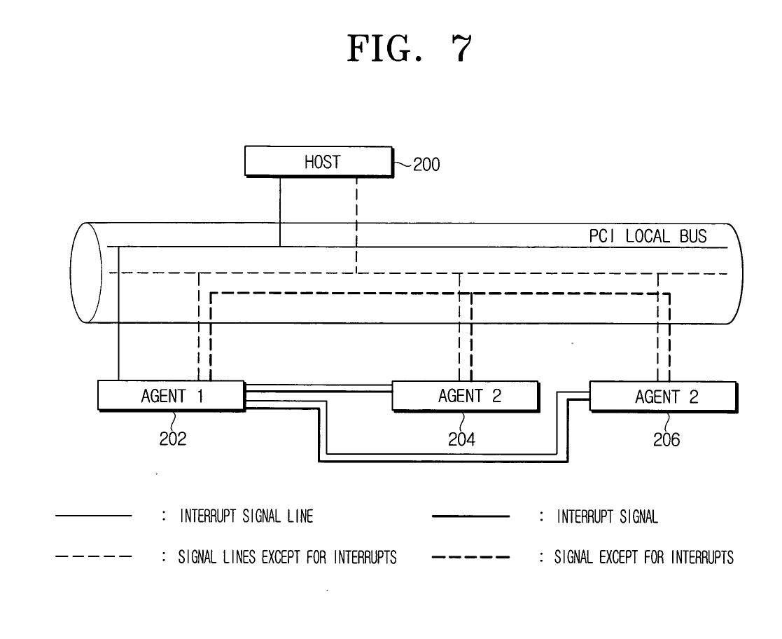

FIG. 7 is a view showing an exemplary process for sending data between multiple agents according to an embodiment of the present invention. Hereinafter, description will be made in detail on a process for sending data from the agent 2 to the agent 1 with reference to FIG. 7.

In FIG. 7, the PCI local bus system has the host 200, agent 202 (agent 1), and agents 204 and 206 (agents 2). In general, the PCI local bus system may include other devices in addition to the above devices, but FIG. 7 shows that the devices are limited to the host 200, agent 202, and agents 204 and 206 for the sake of convenience.

As described in FIG. 3 through FIG. 5, the agents 204 and 206 are controlled by the agent 202.

As shown in FIG. 7, the agent 202 is directly connected to the agents 204 and 206 by an interrupt signal line. If the agent 204 has data to be sent to the agent 202, the agent 202 sends whether it has the data by using the interrupt signal line. The agent 202 becomes aware that the data to be sent to the agent 202 has been stored in the agent 204, using information sent through the interrupt signal line. Since the agent 202 has a memory region for the agent 204, the agent 202 can receive the data regardless of the host 200. The agent 204 first generates an interrupt, so the agent 204 can notify the agent 202 that the agent 204 has data to be sent to the agent 202. Further, the agent 204 first sends the data to the agent 202, and generates an interrupt, enabling the agent 202 to process the data that has been sent.

If the agent 206 also has data to be sent to the agent 202, the agent 202 sends whether it has the data by using the interrupt signal line. The agent 202 becomes aware that the data to be sent to the agent 202 has been stored in the agent 206, using information sent through the interrupt signal line. Since the agent 202 has a memory region for the agent 206, the agent 202 can receive the data regardless of the host 200. The agent 206 first generates an interrupt, so the agent 206 can notify the agent 202 that the agent 206 has data to be sent to the agent 202. Further, the agent 206 first sends the data to the agent 202, and generates an interrupt, enabling the agent 202 to process the data that has been sent.

The agents 204 and 206 operate independently with respect to the agent 202.

The existing method can be used for the data and interrupts to be sent between the host and agents. That is, embodiments of the present invention disclose a method for processing information sent by agents regardless of the host.

As stated above, embodiments of the present invention enable direct communications between agents without the intervention of the host if a specific agent sends data to other agents, with no need to directly send data to the host, under the PCI local bus system. Such communications between agents reduce the load to the PCI local bus system, and enables data to be sent at a higher speed.

The foregoing embodiments and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

1. A bus system, comprising:
a host for controlling the bus system;
a first agent adapted to send and receive data to and from the host; and
at least one second agent adapted to send and receive data directly to and from the first agent.

2. The bus system as claimed in claim 1, wherein the first and second agents are connected by an interrupt line for notifying each other whether a data signal is sent.

3. The bus system as claimed in claim 2, wherein the first and second agents are connected by an interrupt signal line externally the bus system.

4. The bus system as claimed in claim 1, wherein the host is a control unit of an image-forming apparatus.

5. The bus system as claimed in claim 1, wherein the first agent is a wire network card, and the second agent is a wireless module.

6. The bus system as claimed in claim 1, wherein the second agent sends an interrupt notifying the first agent that data to be sent occurs through the interrupt signal line, and then sends the data.

7. The bus system as claimed in claim 1, wherein the second agent sends data to the first agent, and sends to the first agent through the interrupt signal line an interrupt for processing the data.

8. A method for controlling a bus system having a host and at least a first agent and at least one second agent, comprising the steps of:
activating the bus system;
setting by the host a device driver of the first agent for driving the first agent; and
setting by the first agent a device driver of the second agent for driving the second agent.

9. The method as claimed in claim 8, comprising a step of sending data by the second agent to the first agent by using the set device driver.

10. The method as claimed in claim 9, wherein the second agent sends to the first agent through the interrupt signal line an interrupt notifying the first agent that a data-to-be-sent signal occurs by using the set device driver, and sends data to the first agent.

11. The method as claimed in claim 9, wherein the second agent sends data by using the set device driver, and sends an interrupt for processing the data to the first agent through the interrupt signal line.

12. The method as claimed in claim 8, wherein the step of setting by the host the device driver of the first agent sets in the first agent a memory region for storing only data received from the second agent.

13. The method as claimed in claim 8, wherein the activation step detects the agents constituting the bus system.

14. The method as claimed in claim 8, wherein the first agent detects the second agent constituting the bus system.

15. The method as claimed in claim 8, wherein the activation step initializes the bus system.

16. The method as claimed in claim 8, wherein the bus system is a PCI local bus system.
